(19) United States
(12) Patent Application Publication
(10) Pub. No.: US 2011/0136444 A1
(43) Pub. Date: Jun. 9, 2011

(54) Transmit and receive antenna

(76) Inventors: Mark Rhodes, West Lothian (GB); Brendan Hyland, Edinburgh (GB)

(21) Appl. No.: 12/634,493

(22) Filed: Dec. 9, 2009

(51) Int. Cl. H04B 1/44

(52) U.S. Cl. 455/78

(57) ABSTRACT

A transmit/receive antenna for transmission and reception of electromagnetic signals. The transmit/receive antenna comprises a TX section and an RX section, where the TX section comprises a magnetically coupled TX element and a TX input terminal and the RX section comprises at least one magnetically coupled RX element and has an RX output terminal. Axes of the TX loop element and the at least one magnetically coupled RX solenoid element are parallel. Moreover, the at least one magnetically coupled RX element is positioned to provide high isolation at the RX terminal of the antenna from TX electrical signals fed to the TX input. Specifically, the at least one magnetically coupled RX element is positioned at a so that the net magnetic flux generated by the TX loop element and threading the RX solenoid element is zero.

### CROSS-REFERENCE TO RELATED APPLICATIONS

This application is related to commonly owned U.S. Ser. No. ______, filed concurrent with this application, identified as Attorney Docket No. WIR 0032, and entitled “Precision Alignment System”, which application is fully incorporated herein by reference.

### FIELD OF USE

The present invention relates to the field of magnetically coupled transmit/receive antennas for use in low frequency wireless communications systems.

### DESCRIPTION OF THE RELATED ART

Magnetically coupled transmit/receive antennas comprising loop or coil elements which are co-located or closely spaced have multiple applications in systems which are based on the transmission and reception of low frequency electromagnetic signals. One such application is in wireless communications through conductive media. For example, a system for wireless communications through water is taught in United States Patent Application Publication 2006/0286931; “Underwater Communications System ad Method”; Rhodes et al. A system for through-the-earth wireless communications is taught in U.S. Pat. No. 7,043,195; “Communications System”; Bunton et al. Further applications of magnetically coupled transmit/receive antennas comprising loop or coil elements include wireless identification tags, navigation systems, ship-to-ship communications, Electronic Article Surveillance (EAS) systems, object detection and remote sensing.

A technical problem in transmit and receive systems comprising loop or coil elements for low frequency applications where the transmit and receive antennas are closely spaced arises due to a conflict caused by the high levels of power which are necessarily transmitted by the transmit section of the antenna and the very high sensitivity which is required of the receive section of the antenna. These two requirements are substantially mutually exclusive. For example, a transmit section of an antenna for low frequency applications is typically designed to have a low impedance, to have a self-resonant frequency well above the operating band of the antenna and is typically formed of a small number of windings of thick electrically conductive wire forming a coil or loop; on the other hand, the receive section of the antenna is typically designed to be resonant in the band of operation, is designed having a very large number of windings of thin wire, and is typically formed over a magnetic core so as to further increase the magnetic moment of the antenna. When the transmit section of the antenna and the receive section of the antenna are co-located, or are located side by side, problems arise from the very high levels of power to which the receive section of the antenna is subject; moreover, problems arise from the impedance loading effect of the receive section of the antenna on the transmit section.

U.S. Pat. No. 5,321,412, Kopp et al describes a transmit/receive antenna comprising an outer transmit loop antenna, an inner transmit loop antenna and a receive loop antenna, where the three loops share a common axis, and where the receive antenna is positioned between the inner and outer transmit loop antennas at a null so as to provide isolation of the receive antenna from the transmit antenna.

The antenna taught in Kopp provides a partial solution to the problem described above, however, the receive antenna, positioned between the transmit inner loop and transmit outer loop, necessarily has a low sensitivity and thus that antenna system is suitable only for very short range communications.

A search coil arrangement for the head of a metal detector is taught in U.S. Pat. No. 493,816, “Balanced Search Loop for Metal Detector”; Johnson. The coil arrangement taught in Johnson comprises a transmit loop 20, and a receive loop 22 with a balancing section 24, where transmit loop 20, receive loop 22 and balancing section 24 are substantially co-axial. Receive loop 22 and balancing section 24 are connected so that the transmitted signal by transmit loop 20 is not detected. A similar arrangement is taught in U.S. Pat. No. 4,255,711 “Coil Arrangement for Search Head of a Metal Detector” Thompson. The coil arrangements taught in Johnson and Thompson suffer from the drawback that the receiver coil sensitivity is reduced by the requirement that the coils are co-axial.

### SUMMARY OF THE INVENTION

An antenna comprising a magnetically coupled transmit element and a magnetically coupled receive element, and which is capable of providing both high isolation from the transmit section to the receive section, where the transmit section and the receive section are closely spaced, and where the receive section has a very high sensitivity would be a highly beneficial development in systems which are based on the transmission and reception of low frequency electromagnetic signals.

For brevity the term TX is used hereinafter when referring antennas or sections or elements of antennas that are used for transmitting signals, also the term RX is used hereinafter when referring to antennas or sections or elements of antennas which are used to receive signals.

Accordingly, to a first aspect of the present invention, there is provided a transmit/receive antenna for transmission and reception of electromagnetic signals.

The transmit/receive antenna comprises a TX section and an RX section, where the TX section comprises a magnetically coupled TX element and a TX input terminal and the RX section comprises at least one magnetically coupled RX element and has at least one RX output terminal.

The transmit/receive antenna of the present invention has two modes of operation, a TX mode and an RX mode. In the TX mode of operation, TX electrical signals fed to the TX input of the TX section are output by the antenna as TX electromagnetic signals. In the RX mode of operation, RX electromagnetic signals incident on the RX section of the antenna produce an RX electrical signal at the RX output terminal of the antenna.

The TX section and the RX section of the transmit/receive antenna of the present invention are closely spaced.

Specifically, the RX section is positioned relative to the TX section so that the RX section has a very low sensitivity for receiving the TX electromagnetic signals transmitted by the TX section of the antenna of the present invention.

Thus, the present invention provides high isolation at the RX output terminal of the antenna from TX electrical signals fed to the TX input.

The high isolation at the RX terminal of the antenna from TX electrical signals fed to the TX input is achieved by careful positioning and orientation of the various elements of the TX and RX sections of the transmit/receive antenna of the present invention.

Preferably, the TX and RX sections of the antenna of the present invention are positioned so that a magnetic field induced by an electrical signal applied at the TX input port produces a net zero magnetic flux in the RX section of the antenna.

In some embodiments, the magnetically coupled TX element of the transmit/receive antenna of the present invention is a loop formed of an electrically conductive material. Preferably, the electrically conducting loop has lateral XY dimensions which are less than axial Z dimensions thereof.

In some embodiments, the at least one magnetically coupled RX element of the transmit/receive antenna of the present invention is a solenoid, having lateral XY dimensions which are less than axial Z dimensions thereof.

Typically, the RX solenoid element of such embodiments of the present invention comprises multiple turns of electrically conductive wire. For example, the wire may be wound in a spiral so as to form a cylindrical solenoid.

Preferably, the RX solenoid element of such embodiments of the present invention is formed on a core of a material with a high magnetic permeability.

In some embodiments the TX section of the transmit/receive antenna of the present invention comprises a small number of turns of wire of an electrically conductive material, and the RX section comprises a large number of turns of wire of an electrically conductive material. For example, the TX section may comprise between 10 and 100 turns of wire, whereas the RX section may comprise between 100 and 10,000 turns of wire. Practically, the number of turns in the TX section is limited by the need that the TX section be capable of carrying a large current, and hence is capable of accepting a high power input fed to the TX input. On the other hand, the number of turns in the RX section is not limited by any particular need to withstand a high current, and moreover, a large number of turns increases the sensitivity of the RX section of the antenna.

In some embodiments, the RX section of the antenna of the present invention comprises three separate RX elements orientated at right angles relative to each other, so as to receive components of an electromagnetic signal in three dimensions.

Preferably, the TX section of the antenna of the present invention and one element of the RX section are aligned so that their axes are parallel and are spaced apart at a distance so that an electrical signal applied at the TX input port does not appear at the RX output port.

Accordingly, to a second aspect of the present invention, there is provided a wireless communications system comprising a transmit/receive antenna for transmission and reception of electromagnetic signals having closely spaced TX and RX sections, a TX input terminal and at least one RX output terminal, which provides high isolation at the RX output terminal of the antenna from TX electrical signals fed to the TX input.

Embodiments of the present invention will now be described with reference to the accompanying figures in which:

### BRIEF DESCRIPTION OF DRAWINGS

FIG. 1 shows a transmit/receive antenna according to a first embodiment of the present invention.

FIG. 2 shows a transmit/receive antenna according to a second embodiment of the present invention.

FIG. 3 shows a plot of the axial Z component of the magnetic field generated by a circular loop antenna with distance from the centre of the loop and for a range of different axial displacements.

FIG. 4 shows a plot of the locus of XZ coordinates where the axial Z component of the magnetic field from a current loop is zero.

FIG. 5 shows a diagram illustrating the experimentally measured power transferred from a TX loop antenna, such as TX section 11 of FIG. 1 to an RX solenoid antenna, such as RX section 12 of FIG. 1 as a function of the Distance D, from the centre of the RX solenoid antenna to the edge of the TX loop antenna.

FIG. 6 shows a transmit/receive antenna according to a third embodiment of the present invention.

FIG. 7 shows a transmit/receive antenna according to a fourth embodiment of the present invention.

FIG. 8 shows a transmit/receive antenna according to a fifth embodiment of the present invention.

### DETAILED DESCRIPTION

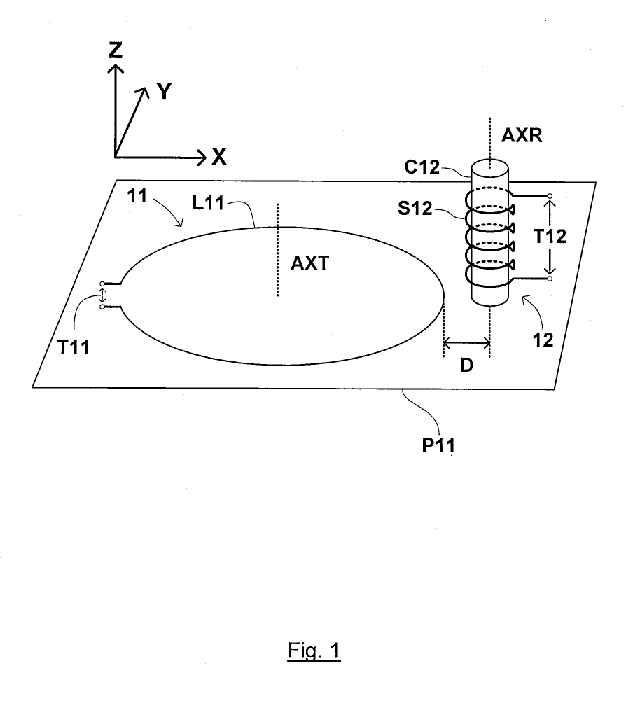

FIG. 1 shows a diagram illustrating a first embodiment of a transmit/receive antenna of the present invention.

The transmit/receive antenna of FIG. 1 comprises TX section 11 and RX section 12, where TX section 11 and RX section 12 are located side by side. TX section 11 comprises magnetically coupled TX loop element L11 and TX input terminal T11 and RX section 12 comprises magnetically coupled RX solenoid element S12 wound on cylindrical core C12 and further comprises RX output terminal T12.

The transmit/receive antenna of FIG. 1 has two modes of operation, a TX mode and an RX mode. In the TX mode of operation, TX electrical signals fed to the TX input T11 of the TX section are output from TX section 11 as electromagnetic signals. In the RX mode of operation, RX electromagnetic signals incident on RX section 12 of the antenna produce an RX electrical signal at RX output terminal T12.

The transmit/receive antenna of FIG. 1 has a TX operating band and an RX operating band. Typically, the TX operating band and the RX operating band are located in the same region of the electromagnetic spectrum. In several applications, the TX operating band and the RX operating band overlap.

TX section 11 and RX section 12 are positioned so that they both are located on one side of a plane P11. In addition, TX section 11 and RX section 12 are both oriented so that their respective axes AXT, AXR point in the Z direction, as shown by the co-ordinate system illustrated in the top left-hand portion of FIG. 1. Moreover, axis AXR of RX solenoid element 12 is offset by a distance D from the edge of TX loop element L11.

The distance D is chosen so that RX section 12 has very low efficiency for receiving the TX electromagnetic signals produced by TX section 11. Thus, the antenna of the present invention provides high isolation at RX output terminal T12 of TX electrical signals which are fed to TX input terminal T11.

Magnetically coupled TX loop element L11 is formed of electrically conductive wire. Typically, TX loop element L11 comprises a plurality of loops of wire; however a single loop is also an option. The number of loops are selected based on the frequency of operation, the required efficiency of the antenna and based on the ideal terminating impedance of the transmitter circuit (not shown) to which TX input terminal T11 is connected. The lateral XY dimensions of TX loop element L11 are substantially greater than axial Z dimensions thereof.

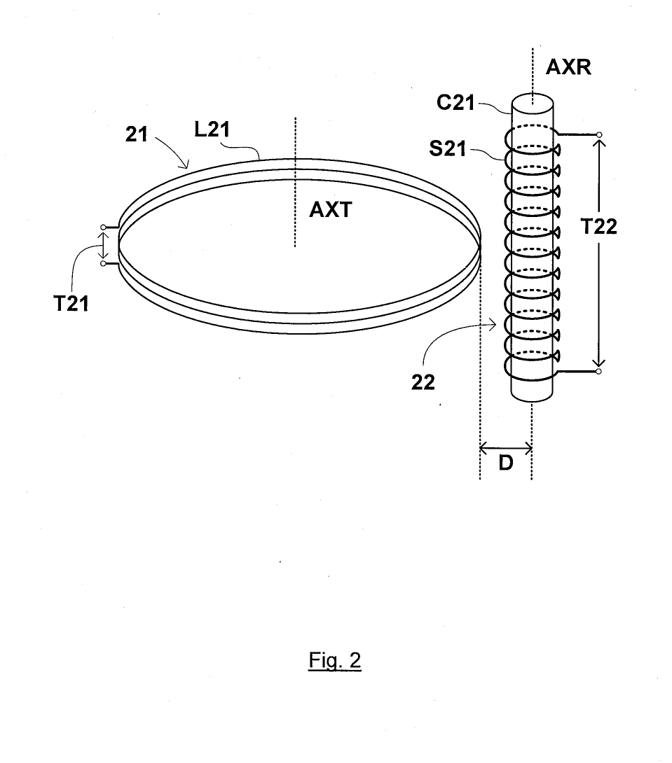

FIG. 2 shows a transmit/receive antenna according to a second embodiment of the present invention.

The transmit/receive antenna of FIG. 2 shares many of the features of the transmit/receive antenna of FIG. 1, E.G. TX section 21 and RX section 22 located side by side, where TX section 21 comprises magnetically coupled TX loop element L21 and TX input terminal T21 and where RX section 22 comprises magnetically coupled RX solenoid element S22 wound on cylindrical core C22 and further comprises RX output terminal T22.

The transmit/receive antenna of FIG. 2 has two modes of operation, a TX mode and an RX mode. In the TX mode of operation, TX electrical signals fed to the TX input T21 of the TX section are output from TX section 21 as electromagnetic signals. In the RX mode of operation, RX electromagnetic signals incident on RX section 22 of the antenna produce an RX electrical signal at RX output terminal T22.

The transmit/receive antenna of FIG. 2 has a TX operating band and an RX operating band. Typically, the TX operating band and the RX operating band are located in the same region of the electromagnetic spectrum. In some applications, the TX operating band and the RX operating band overlap.

TX loop element L21 of TX section 21 of the transmit/receive antenna of FIG. 2 comprises several windings of an electrically conductive wire. The number of windings of TX loop element L21 is chosen so as to provide a balance between the increased magnetic moment resulting from a greater number of windings, and the increased self resonant frequency (SRF) of TX loop element L21 resulting from a fewer number of windings. Typically, TX loop element L21 is designed so that its SRF falls at a frequency that is several times higher than the TX operating band of the antenna.

RX solenoid element S22 comprises several windings of an electrically conductive wire. The number of windings of RX solenoid element S22 is chosen so as to provide the maximum sensitivity of RX section 22 for receiving RX electromagnetic signals in the RX operating band of the antenna.

RX solenoid element S22 may be formed over a core of a material having a high magnetic permeability. The magnetic moment M of RX solenoid element S22 is defined by the following equation.

M=μiN×A

where i is the current flowing in RX solenoid element S22, N is the number of windings, A is the area of the loop and 8 is the magnetic permeability of the material of the core C22.

TX loop element L21 and RX solenoid element S22 are both oriented so that their respective axes AXT, AXR point in the same direction. Moreover, axis AXR of RX solenoid element 12 is offset by a distance D from the edge of TX loop element L11. The distance D is chosen so as to provide very high isolation from TX input terminal T11 to RX output terminal T12.

In the embodiment of the present invention depicted in FIG. 2, TX loop element L21 is located approximately midway along the length of RX solenoid element. This arrangement provides an increased sensitivity of RX solenoid element compared with the arrangement of FIG. 1 where TX loop element L11 and RX solenoid element S11 are both located on one side of plane P11.

A highly beneficial feature of the transmit/receive antenna of the present invention is that the RX section of the transmit/receive antenna of the present invention is isolated from the TX section.

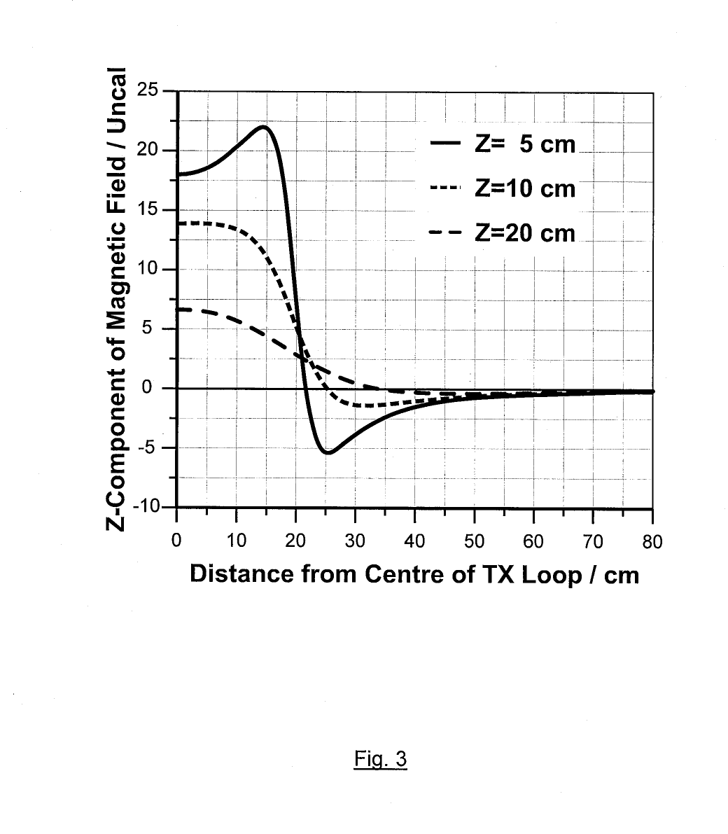

FIG. 3 shows several plots of the Z-component of the magnetic field strength produced from a current flowing in a circular loop antenna, which is positioned in a three dimensional co-ordinate system so that the circular loop antenna is in the XY plane. Three plots are shown in FIG. 3, where each plot gives the Z-component of the magnetic field along lines which are parallel to the X axis and extend from the centre of the loop antenna and which are defined by Z distances of 5 cm, 10 cm and 20 cm respectively. For the plots of FIG. 3, the loop antenna is circular and has a radius of 20 cm. The units on the vertical axis of the plot of FIG. 3 are not calibrated; a scaling factor applies for each different propagating medium due to variations in the electrical conductivity and/or the magnetic permeability thereof.

It can be seen from each of the plots FIG. 3 that the Z-component of magnetic field strength is positive for values of the X distance which are less than the loop radius, falls to zero just outside the loop and then decreases to a negative value as the X distance is further increased.

It can further be seen from the plots FIG. 3 that the X distance for which the Z-component of magnetic field equals zero increases as the Z distance is increased.

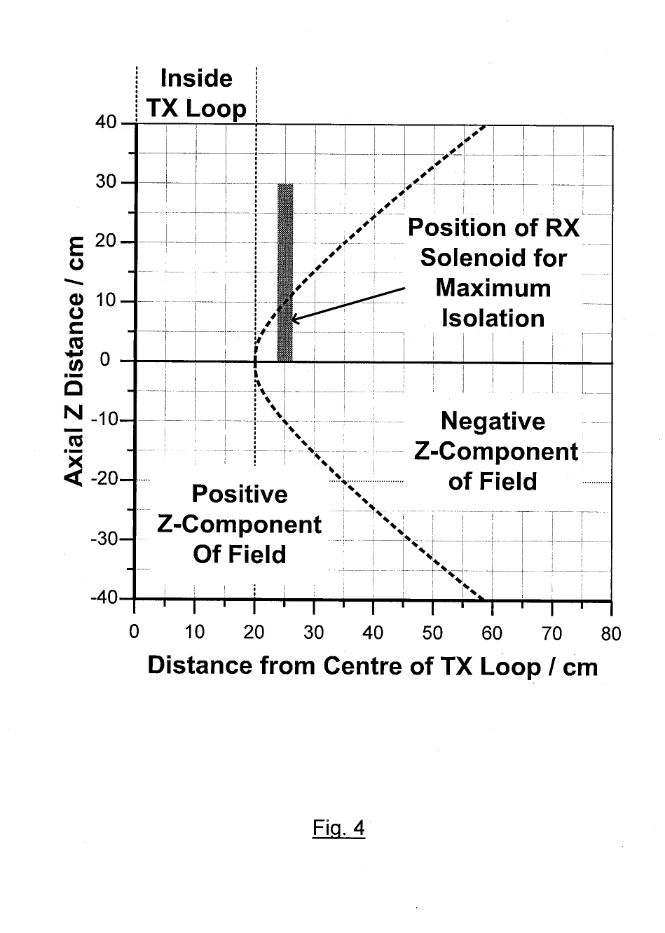

FIG. 4 shows a plot in the XZ plane of the locus of points defined by a zero value of the Z component of the magnetic field strength produced from a current flowing in the a circular loop antenna. The dimensions of the circular loop antenna for the plot of FIG. 4 are the same as the dimensions of the loop antenna for the plots of FIG. 3. It can be seen in FIG. 4 that the XZ plane is divided into two regions: a region where the Z component of the magnetic field is positive, and a region where the Z component of the magnetic field is negative.

FIG. 4 also shows the position of a solenoid antenna where the net magnetic flux through the antenna is zero. This position corresponds to the optimum position of a RX solenoid element (such as S12 of FIG. 1) about a TX loop element (such as L11 of FIG. 1) to produce the maximum isolation of the TX solenoid element from the TX loop element.

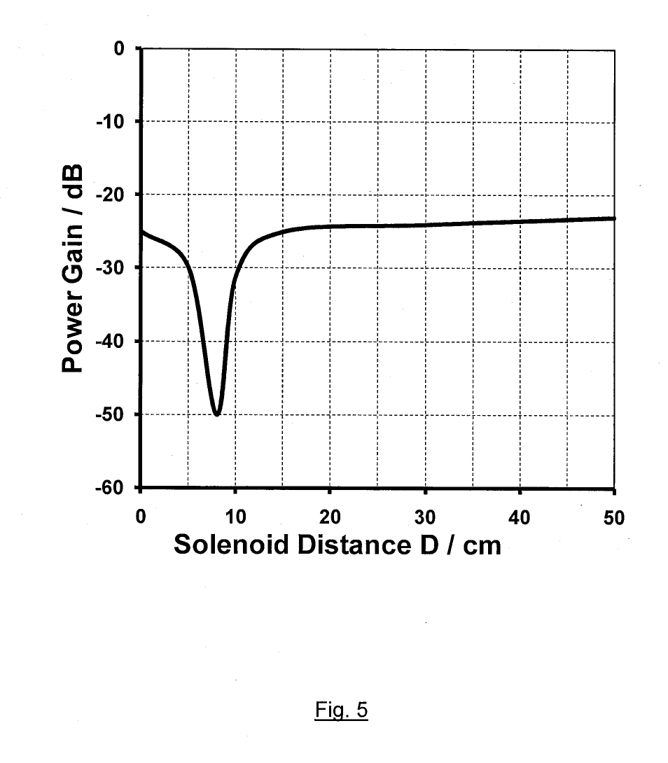

FIG. 5 shows a plot of the experimentally measured power transferred between a loop antenna and a solenoid antenna, as the distance D of the centre of the solenoid antenna to the edge of the loop antenna is increased. For the experimental measurement of FIG. 5, the loop antenna had a radius of 20 cm, the solenoid antenna had a diameter of 2 cm; both antennas were orientated so that their axes pointed in the same direction. The plot begins with the solenoid antenna positioned so that its central axis intersects the edge of the loop antenna. It can be seen from FIG. 5 that the power transferred from one antenna to the other falls to zero for a distance of 8 cm.

FIG. 5 illustrates the principle that for a transmit/receive antenna comprising a TX loop element and an RX solenoid element, with axes which are aligned, an emf is induced in the RX solenoid antenna when a signal is fed to a TX input of the TX loop antenna. However, according to a principle of the present invention, there is one unique position of the RX solenoid antenna where the induced emf falls to zero. This phenomenon provides a useful means for designing a transmit/receive antenna comprising a TX loop element and an RX solenoid element where that there is a high level of isolation from the TX loop element to the RX solenoid element.

The high isolation of the RX section of the transmit/receive antenna of the present invention from the TX section provides the benefit that the load at the TX input of the TX section is determined by the properties of the TX section alone, and is not affected by the properties of the RX section; hence, TX electrical signals which are fed to the TX input of the TX section of the antenna are not influenced by the RX section.

In conventional transmit/receive antennas, the RX section must be designed taking into account the effects of signals which may be induced due to the close proximity of the TX section to the TX section. For example, a conventional antenna comprises an RX section having multiple windings of wire, the greater the number of windings the greater sensitivity; at the same time the TX section typically comprises a small number of windings of wire so as to present the optimum load to the transmitter output. This arrangement produces voltage transformation from the TX section of the antenna to the RX section, with the result that very high voltages may be induced in the RX section. The induced voltages in the RX section increase as the ratio of windings in the RX to windings in the TX section increases, and as the level of coupling between the TX section and the RX section increases. The high voltages which may be induced in the RX section limit the number of windings which may be used, and consequently limit the sensitivity of the RX section of the antenna. Time domain multiplexing of the transmit and receive functions of the transceiver will prevent the large signals from entering the receiver; however, the high voltages in the receiver antenna introduce undesirable high breakdown voltage requirements of the RX section.

A further benefit of the transmit/receive antenna of the present invention, is that the RX section is not influenced by TX electrical signals which are fed to the TX input of the TX section of the antenna. For example, very high TX power levels in the TX section of a conventional transmit/receive antenna will induce large electrical signals in the RX section. If the RX section of the antenna is formed over a core of a material with a high magnetic permeability, the large currents which flow in the RX section of the antenna during the TX mode of operation may saturate the core of the RX section, thereby limiting the sensitivity of the RX section during the RX mode of operation. Typically, a transmit/receive antenna is switched from TX mode to RX mode during operation. The switching provides isolation of the receiver circuitry from the high power levels of the transmitter circuit; however, the switching has no effect on currents induced in the RX section of the antenna as a result of parasitic capacitances therein. Thus, high power levels in the TX section, can induce similarly high power levels in the RX section and whereas the TX section is designed to withstand high power levels, the RX section typically is not; magnetic permeable cores become easily saturated under high power conditions, reducing the beneficial effect they may have on received antenna sensitivity.

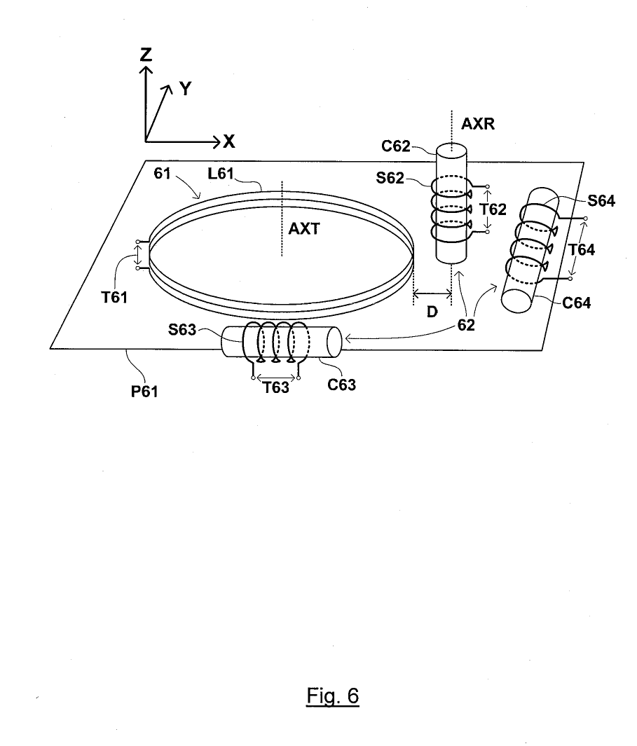

FIG. 6 shows a diagram illustrating a third embodiment of the present invention.

The transmit/receive antenna of FIG. 6 comprises TX section 61 and RX section 62, where TX section 61 and RX section 62 are located near each other on one side of a plane P62. TX section 61 comprises magnetically coupled TX loop element L61 and TX input terminal T61. Magnetically coupled loop element L61 is formed of multiple windings of wire of an electrically conducting material. Magnetically coupled loop element L61 is orientated so that it lies in the XY plane and so that a central axis thereof AXT is parallel to the Z axis of a local co-ordinate system—shown in the top left hand portion of FIG. 6. RX section 62 comprises first magnetically coupled RX solenoid element S62 wound on cylindrical core C62 and connected to RX output terminal T62, second magnetically coupled RX solenoid element S63 wound on cylindrical core C63 and connected to RX output terminal T63 and further comprises third magnetically coupled RX solenoid element S64 wound on cylindrical core C64 and connected to RX output terminal T64.

The transmit/receive antenna of FIG. 6 has two modes of operation, a TX mode and an RX mode. In the TX mode of operation, TX electrical signals fed to the TX input T61 of TX section 61 are output as electromagnetic signals. In the RX mode of operation, RX electromagnetic signals incident on RX section 62 of the antenna produce an RX electrical signal at one or more of RX output terminals T62, T63, T64. The output terminal carrying the largest RX electrical signal depends on the direction of the RX electromagnetic signals incident on RX section 62.

First RX solenoid element S62 is oriented so that a central axis AXR is parallel to the Z-axis of the local co-ordinate system. Central axis AXR of first RX solenoid element S62 is offset from the edge of TX loop element L61 by an offset distance D. The offset distance D is selected so as to provide the maximum isolation of RX solenoid element S62 from TX signals transmitted by TX section 61. The manner of determination the distance D is as described in the text relating to FIG. 3, FIG. 4 and FIG. 5 of the present invention. Nonetheless, distance D may be determined experimentally, by positioning solenoid loop element S62, at an arbitrary distance D from magnetically coupled TX loop element L61, by applying alternating electrical signals to TX input terminal T61 and by measuring signals at RX output terminal R62. The optimum distance D corresponds to the position of solenoid RX element S62 where none of the TX signal is detected at RX output terminal T62.

Second RX solenoid element S63 is oriented so that a central axis (not shown) is parallel to the X-axis of the local co-ordinate system and so that it lies in the plane of TX loop element L61. Second RX solenoid element S63 can receive RX electromagnetic signals incident on RX section 62 without interference from TX signals transmitted by magnetically coupled TX loop element L61 due to the fact that the direction of the magnetic field lines of TX signals emitted by TX loop element L61 are perpendicular to the central axis of second RX solenoid element S63.

Third solenoid element S64 is oriented so that a central axis (not shown) is parallel to the Y-axis of the local co-ordinate system and so that it lies in the plane of TX loop element L61. Third RX solenoid element S64 also is not affected by interfering TX signals transmitted by magnetically coupled TX loop element L61 due to the fact that the direction of the magnetic field lines of TX signals emitted by TX loop element L61 are perpendicular to the central axis of third RX solenoid element S64.

As described herein, RX section 62 comprises first magnetically coupled RX solenoid element S62 wound on cylindrical core C62 and orientated in the Z direction, second magnetically coupled RX solenoid element S63 wound on cylindrical core C63 and orientated in the X direction, third magnetically coupled RX solenoid element S64 wound on cylindrical core C64 and orientated in the Y direction, RX output terminal T62, RX output terminal T63 and RX output terminal T64. Thus RX section 62 is capable of receiving the magnetic component of electromagnetic signals incident on RX section 62 regardless of the orientation of the RX signals and consequently RX section 62 of the transmit receive antenna of the third embodiment of the present invention depicted in FIG. 6 is an omni-directional RX antenna.

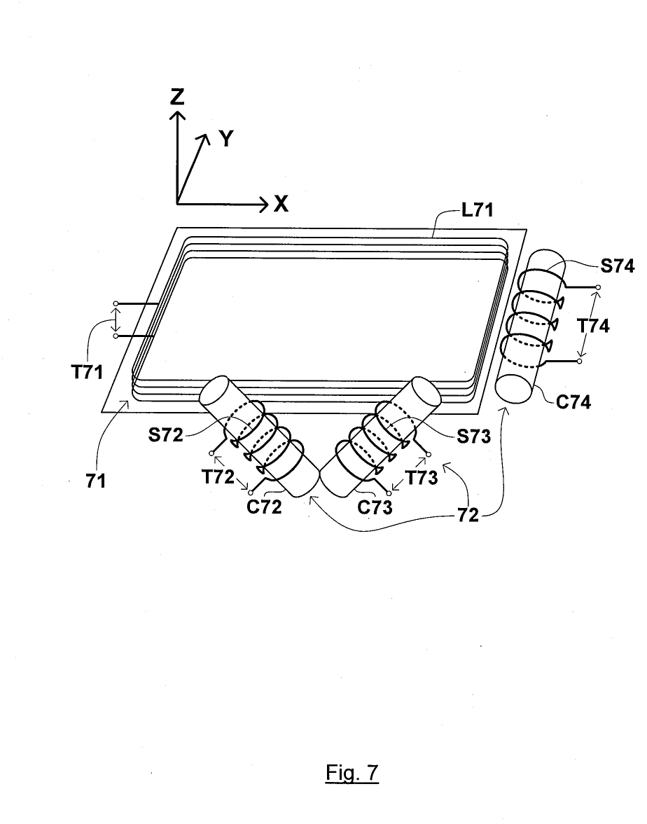

FIG. 7 shows a diagram illustrating a transmit/receive antenna according to a fourth embodiment of the present invention.

The transmit/receive antenna of FIG. 7 comprises TX section 71 and RX section 72, where their respective constituent elements are located so that TX section 71 and RX section 72 are adjacent to each other. TX section 71 comprises magnetically coupled TX loop element L71 and TX input terminal T71. Magnetically coupled TX loop element L71 comprises multiple windings of wire of an electrically conducting material and formed into a rectangle. Magnetically coupled rectangular loop element L71 is orientated so that it lies in the XY plane of a local co-ordinate system—shown in the top left hand portion of FIG. 7. RX section 72 comprises first magnetically coupled RX solenoid element S72 wound on cylindrical core C72 and connected to RX output terminal T72, second magnetically coupled RX solenoid element S73 wound on cylindrical core C73 and connected to RX output terminal T73 and further comprises third magnetically coupled RX solenoid element S74 wound on cylindrical core C74 and connected to RX output terminal T74.

The transmit/receive antenna of FIG. 7 has two modes of operation, a TX mode and an RX mode. In the TX mode of operation, TX electrical signals fed to the TX input T71 of TX section 71 are output as electromagnetic signals. In the RX mode of operation, RX electromagnetic signals incident on RX section 72 produce RX electrical signals at one or more of RX output terminals T72, T73, T74. The output terminal carrying the largest RX electrical signal depends on the direction of the RX electromagnetic signal incident on RX section 72.

First RX solenoid element S72 is oriented so that a central axis (not shown) lies in the XZ plane of a local co-ordinate system—shown in the top left hand corner of FIG. 7. Second RX solenoid element S73 is also oriented so that a central axis (not shown) lies in the XZ plane of the local co-ordinate system; however, the central axis of first solenoid element S72 and second solenoid element S73 are also orientated at right angles to each other. Both first RX solenoid element S72 and second RX solenoid element S73 are offset from the edge of TX rectangular loop element L71 in the Y direction by a given distance.

The Y-offset distance of first RX solenoid element S72 and second RX solenoid element is selected so as to provide the maximum isolation from TX signals transmitted by TX section 71. The manner of determination the offset distance is as described in the text relating to FIG. 3, FIG. 4 and FIG. 5 of the present invention. Nonetheless, the distance may also be determined experimentally. In any case, the optimum offset distance corresponds to the position of RX solenoid elements S72 and S73 where TX signals emitted by rectangular loop element L71 are not detected at either of RX output terminals T72 and T73.

Third solenoid element S74 is oriented so that a central axis (not shown) is parallel to the Y-axis of the local co-ordinate system and so that it lies in the plane of TX loop element L61. Third RX solenoid element S74 does not receive TX signals transmitted by magnetically coupled TX loop element L71 due to the fact that the directions of the magnetic field lines of TX signals emitted by TX loop element L71 passing through third RX solenoid element S74 are perpendicular to its central axis.

The combination of first RX solenoid element S72, second RX solenoid element S73 and third RX solenoid element S74 provides an RX section 72 which is an omni-directional RX antenna. Thus RX section 72 is capable of receiving the magnetic component of electromagnetic signals incident on RX section 72 regardless of the orientation of the RX signals.

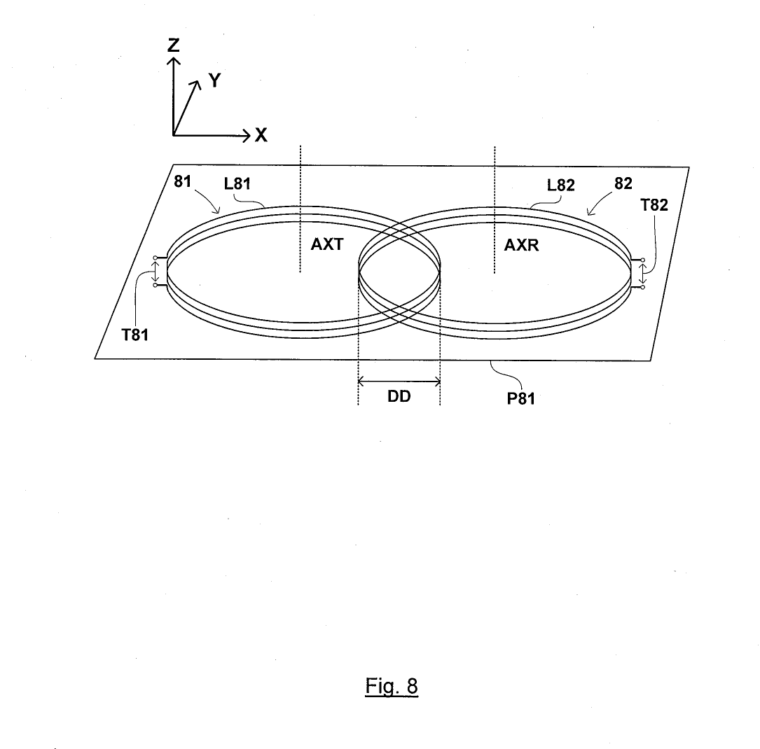

FIG. 8 shows a diagram illustrating a transmit/receive antenna according to a fifth embodiment of the present invention.

The transmit/receive antenna of FIG. 8 comprises TX section 81 and RX section 82, where TX section 81 and RX section 82 are located side by side. TX section 81 comprises magnetically coupled TX loop element L81 and TX input terminal T81 and RX section 82 comprises magnetically coupled RX loop element L82 and further comprises RX output terminal T82.

The transmit/receive antenna of FIG. 8 has two modes of operation, a TX mode and an RX mode. In the TX mode of operation, TX electrical signals fed to the TX input T81 of the TX section are output from TX section 81 as electromagnetic signals. In the RX mode of operation, RX electromagnetic signals incident on RX section 82 of the antenna produce an RX electrical signal at RX output terminal T82.

The transmit/receive antenna of FIG. 8 has a TX operating band and an RX operating band. Typically, the TX operating band and the RX operating band are located in the same region of the electromagnetic spectrum. In several applications, the TX operating band and the RX operating band overlap.

TX section 81 and RX section 12 are positioned so that they both are located on one side of a plane P11. In addition, TX section 81 and RX section 82 are both oriented so that their respective axes AXT, AXR point in the Z direction, as shown by the co-ordinate system illustrated in the top left-hand portion of FIG. 8. TX loop element L81 is offset from RX loop element L82 by a distance DD. The distance DD is chosen so as to provide very high isolation from TX input terminal T11 to RX output terminal T12.

Specifically, the transmit/receive antenna of FIG. 8 is designed so that RX section 82 has very low efficiency for receiving the TX electromagnetic signals produced by TX section 81. Thus, the antenna of the fifth embodiment of the present invention depicted in FIG. 8 provides high isolation at RX output terminal T82 of TX electrical signals which are fed to TX input terminal T81.

Magnetically coupled TX loop element L81 is formed of electrically conductive wire. Typically, TX loop element L81 comprises a plurality of loops of wire. The number of loops of wire is selected based on the frequency of operation, the required efficiency of the antenna and based on the ideal terminating impedance of the transmitter circuit (not shown) to which TX input terminal T81 is connected. The lateral XY dimensions of TX loop element L81 are substantially greater than axial Z dimensions thereof.

Magnetically coupled RX loop element L82 is also formed of electrically conductive wire. Typically, RX loop element L82 comprises a plurality of loops of wire. The number of loops of wire is selected based on the frequency of operation, and the required sensitivity of the antenna. Typically, a very large number of windings is preferred. The lateral XY dimensions of RX loop element L82 are substantially greater than axial Z dimensions thereof.

Embodiments of the transmit/receive antenna of the present invention described herein are generally suited to applications involving the transmission of electromagnetic signals in through conductive media. Specific applications of the present invention include wireless systems operating underwater, in fresh water or in seawater and similarly applications involving the transmission of electromagnetic signals underground.

Applications of the transmit/receive antenna of the present invention described herein include wireless communications, such as voice telephony, data transfer, the transmission and reception of video. Other applications include navigation, and remote sensing based on the transmission and reception of electromagnetic signals. Further applications include systems for the detection of metallic objects, or objects having ferromagnetic properties. Still further applications include systems for tracking the motion of an autonomous underwater vehicle (AUV) or a remotely operated vehicle (ROV) as the vehicle moves along an underwater pipeline.

Any optimization of the present invention for other environments would be obvious to a practitioner skilled in this area and hence remains within the scope of the present invention.

The above descriptions of the specific embodiments are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. A transmit/receive antenna
said transmit/receive antenna comprising a TX section and an RX section, said TX section comprising a magnetically coupled TX element and a TX input terminal, said RX section comprising at least one magnetically coupled RX element and at least one RX output terminal
said transmit/receive antenna having a TX mode of operation during which TX electrical signals fed to said TX input of said TX section are output from said antenna as TX electromagnetic signals,
said transmit/receive antenna having an RX mode of operation during which RX electromagnetic signals incident on said RX section produce an RX electrical signal at said at least one RX output terminal,
wherein said RX section and said TX section are closely spaced, said RX section being positioned to have very low sensitivity for receiving said TX electromagnetic signals thereby providing high isolation from said TX input terminal to said at least one RX output terminal.

2. A transmit/receive antenna according to claim 1 wherein said TX and RX sections are spaced apart at a distance so that a magnetic field generated by said magnetically coupled TX element produces a net zero magnetic flux through said at least one magnetically coupled RX element.

3. A transmit/receive antenna according to claim 1 wherein said magnetically coupled TX element is a loop antenna having lateral XY dimensions which are greater than axial Z dimensions thereof.

4. A transmit/receive antenna according to claim 3 wherein said TX loop antenna is formed of a coil of wire having a plurality of windings.

5. A transmit/receive antenna according to claim 3 wherein a lateral XY profile of said TX loop antenna is circular.

6. A transmit/receive antenna according to claim 3 wherein a lateral XY profile of said TX loop antenna is rectangular.

7. A transmit/receive antenna according to claim 3 wherein a central axis of said TX loop antenna is parallel to a central axis of said at least one magnetically coupled RX element.

8. A transmit/receive antenna according to claim 1 wherein said at least one magnetically coupled RX element is a solenoid, having lateral XY dimensions which are less than axial Z dimensions thereof.

9. A transmit/receive antenna according to claim 8 wherein a central axis of said RX solenoid element is parallel to a central axis of said TX element.

10. A transmit/receive antenna according to claim 1 wherein said at least one magnetically coupled RX element is formed on a core of a material with a high magnetic permeability.

11. A transmit/receive antenna according to claim 1 wherein said RX section comprises three separate magnetically coupled RX elements orientated at right angles relative to each other, so as to receive respective components of an electromagnetic signal in three dimensions.

12. A transmit/receive antenna according to claim 11 wherein said three separate magnetically coupled RX elements each have respective RX output terminals.

13. A transmit/receive antenna according to claim 3 wherein said RX section comprises a loop antenna having lateral XY dimensions which are greater than axial Z dimensions thereof.

14. A transmit/receive antenna according to claim 13 wherein said RX loop antenna is formed of a coil of wire having a plurality of windings.

15. A transmit/receive antenna according to claim 13 wherein a lateral XY profile of said RX loop antenna is circular.

16. A transmit/receive antenna according to claim 13 wherein said RX loop antenna at least partially overlaps said TX loop antenna.

17. A wireless communications system comprising a transmit/receive antenna
said transmit/receive antenna comprising a TX section and an RX section, said TX section comprising a magnetically coupled TX element and a TX input terminal, said RX section comprising at least one magnetically coupled RX element and at least one RX output terminal
said transmit/receive antenna having a TX mode of operation during which TX electrical signals fed to said TX input of said TX section are output from said antenna as TX electromagnetic signals
said transmit/receive antenna having an RX mode of operation during which RX electromagnetic signals incident on said RX section produce an RX electrical signal at said RX output terminal of the antenna
wherein said RX section and said TX section are closely spaced said RX section being positioned to have low efficiency for receiving said TX electromagnetic signals thereby providing high isolation from the said TX input terminal to said at least one RX output terminal.
